(19) United States
(12) Patent Application Publication
(10) Pub. No.: US 2022/0315216 A1
(43) Pub. Date: Oct. 6, 2022

(54) DRIVE AND FLY ELECTRIC AND HYBRID VTOL VEHICLE

(71) Applicant: NFT Inc., Los Altos, CA (US)

(72) Inventors: Guy KAPLINSKY, Los Altos Hills, CA (US); Maki KAPLINSKY, Los Altos Hills, CA (US); Kohei KANNO, Santa Clara, CA (US)

(73) Assignee: NFT Inc., Los Altos, CA (US)

(21) Appl. No.: 17/608,774

(22) PCT Filed: May 6, 2020
(86) PCT No.: PCT/IL2020/050498

§ 371 Date: Nov. 4, 2021

Related U.S. Application Data
(60) Provisional application No. 62/844,188, filed on May 7, 2019.

(51) Int. Cl. B64C 37/00; B64C 29/00; B64C 3/56

(52) U.S. Cl. CPC B64C 37/00; B64C 29/0033; B64C 3/56

(57) ABSTRACT

A vehicle adapted to travel on a road and to fly in the air comprises a vehicle fuselage, right and left foldable and deployable wings where each of the wings comprises two folding mechanisms and one tillable ducted fan. The vehicle also comprises one ducted fan installed in the vehicle fuselage and a tillable ducted fan installed at the rear of the vehicle. The vehicle further comprises at least three wheels adapted to allow the vehicle to travel on a road.

### BACKGROUND OF THE INVENTION

Surface and road vehicle traffic, especially in the cities, has already reached the pre-saturation point, and even crossed it. Even in cities with a developed underground transportation system, the on-ground vehicles traffic is typically near its saturation point during a long period of the day.

Attempts to develop safe, easy to control and silent electric and hybrid car/airborne vehicle (HCAV) gained only partial success so far. The contradicting design requirements of size, net lift weight, operational range and operational service height, external dimensions at the car form, the requirement to enable electric-only takeoff and landing, etc. were found so far unfeasible. Certain prior art configurations of electric and hybrid car/airborne vehicle yield merely partial solutions and partial success if at all. Thus, even though exploitation of the “third dimension”, i.e.—use of pass tracks extending in more than only one, earth surface layer—seems to be a ready solution for the traffic jams issues, the design requirements presented above remained till today unsolved.

There is a need for a driving and flying vehicle capable of driving on roads, parking inside car parking lots, taking off and landing from helipad like sites or very short runways and flying considerable distances.

### SUMMARY OF THE INVENTION

A vehicle that is adapted to travel on a road and to fly in the air is disclosed comprising a vehicle fuselage having a longitudinal axis aligned with the X-axis of a virtual reference frame, right and left foldable and deployable wings. The wings extend when deployed, substantially parallel to the Y-axis of the virtual reference frame. The vehicle comprises at least three ducted fans, and at least three wheels adapted to allow the vehicle to travel on a road. Each of the wings comprises wing root folding mechanism, and mid-wing folding mechanism. Two of the at least three ducted fans are wing-tip ducted fans disposed each at the outer tip of one wing, one of the at least three ducted fans is a tail ducted fan disposed at the rear end of the vehicle, comprised in a rear ducted fan assembly.

In some embodiments each of the wing-tip ducted fans is controllably rotatable about an axis that is parallel to the vehicle tilt axis (Y-axis) between a first position in which thrust produced by the wing-tip ducted fan is directed substantially parallel to the Z-axis of the vehicle reference frame and a second position in which thrust produced by the wing-tip ducted fan is directed substantially parallel to the vehicle X-axis.

In some embodiments the rear ducted fan assembly is controllably rotatable about an axis that is parallel to the vehicle tilt axis (Y-axis) between a first position in which thrust produced by the tail ducted fan is directed substantially parallel to the Z-axis of the vehicle reference frame and a second position in which thrust produced by the tail ducted fan is directed substantially parallel to the vehicle X-axis.

In some embodiments the rear ducted fan assembly further comprises at least one rudder fin and at least one elevator fin, wherein the at least one rudder fin is disposed behind the rear ducted fan on a first pivot that is parallel to the Z-axis, the at least one rudder fin is adapted to controllably change its angle with respect to the X-axis about the first pivot and the at least one elevator fin is disposed behind the rear ducted fan on a second pivot that is parallel to the Y-axis, the at least one elevator fin is adapted to controllably change its angle with respect to the X-axis about the second pivot.

In some embodiments at least one of the at least three wheels is motorized.

In some embodiments each of the root folding mechanisms is adapted to enable rotation of the respective wing about a root folding pivot from a stowed position to a deployed position in a plane that is substantially parallel to the X-Y plane.

In some embodiments each of the root folding mechanisms comprises: actuator adapted to rotate the respective wing between a stowed position and a deployed position and locking means adapted to securely lock the respective wing in the stowed position and in the deployed position.

In some embodiments each of the mid-wing folding mechanisms is adapted to enable rotation of the respective outer main part of the wing about a mid-wing folding pivot from a stowed position to a deployed position in a plane that is substantially parallel to the Y-Z plane.

In some embodiments each of the mid-wing folding mechanisms comprises: actuators adapted to rotate the respective outer main part of the wing between a stowed position and a deployed position and locking means adapted to securely lock the respective outer main part of the wing in the stowed position and in the deployed position.

In some embodiments the actuator of the root folding mechanism comprises a spur gear and a rotational actuator.

In some embodiments the fuselage ducted fan comprises a set of controllable vanes adapted to cover and uncover the upper opening of the duct of the fuselage ducted fan.

In some embodiments the area of a cross section of the rear ducted fan done in planes perpendicular to the direction of flow of air through the duct is wider closed to the front and rear openings of the duct and narrower in the middle. In some embodiments the shape of a cross section done in a plane comprising the longitudinal axis of the rear ducted fan of the inner face of the duct ha an aerodynamic shape

A method of changing the form of a vehicle adapted to travel on a road and to fly in the air from flight form to travel form is disclosed comprising: directing all tiltable fans to vertical position, turning all ducted fans off, directing wing-tip ducted fans to angle of stow position, directing rear ducted fan to horizontal position, unlocking locking means of mid-wing folding mechanisms, directing outer main parts of the wings up to vertical position, unlocking locking means of wing root folding mechanism, rotating the wings backward to stow position, folding outer main parts of the wings over the inner main parts and locking all folding mechanisms in stow position.

A method for controlling a process for calculating flight control parameters required for take-off of a vehicle that is adapted to travel on a road and to fly in the air is disclosed. The method comprising receiving input data indicative of at least one item from a list comprising: overall propulsion system specifications, available energy of a propulsion battery, the maximum torque the propulsion battery can provide, the inertia of each of a plurality of ducted fans, the maximal RPM of each of the plurality of the ducted fans, the maximal thrust available from each of the plurality of the ducted fans and rotational moment, speed available for each of at least one motorized wheel of the vehicle, and vehicle aerodynamic coefficients. The method further comprising setting boundary conditions to limit range of changes allowed to be made to the flight controls, analyzing the torque required during the warm up of each of the fans motors and the wheel motors by ramping each of the motors up/down to a predefined RPM and continuously calculating the required toque and adjusting a control time constant for controlling the propulsion system so as to not exceed the maximum torque of the propulsion system. The method further comprising calculating for each of the ducted fans the thrust required for the coming flight maneuver based on the RPM value used for calculation of the previous step and on the actual take-off mass, calculating the acceleration vector, the velocity vector and the distance traveled horizontally and vertically during take-off, based on calculations in previous steps, comparing the calculated required acceleration for take-off and if it is higher than the maximal available acceleration repeatedly adjusting the RPM to lower the calculated required acceleration for take-off, calculating the energy required for take-off and the take-off running distance and terminating the take-off process when the vehicle reached a predetermined termination height.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of 3D space defining the design L/W/H dimension limitations for enclosing a vehicle according to embodiments of the present invention;

FIGS. 2A and 2B present a schematic illustration of an HCAV in “road” position and in “flight” position, respectively, according to embodiments of the invention;

FIG. 3A depicts a graph of dependency of disk loading and power loading on DF diameter.

FIG. 3B is a graph depicting the dependency of the required power for takeoff on the width of the vehicle as function of maximum take-off weight (MToW) and the type of source of electrical power—fuel cell or battery;

FIG. 4 is a schematic partial enlarged isometric illustration of a tail DF assembly, according to embodiments of the invention;

FIG. 5A is a schematic illustration of an inboard folding mechanism and an outboard folding mechanism of left wing, according to embodiments of the invention;

FIG. 5B is a schematic illustration of an inboard folding mechanism, according to embodiments of the invention;

FIG. 5C is a schematic illustration of a folding mechanism shown with regard to a right wing, according to embodiments of the invention;

FIGS. 6A-6F depict six stages of transition of an HCAV from flight form to drive form, according to embodiments of the invention;

FIG. 6G is a schematic flow diagram depicting a process of changing the form of the HCAV from flight mode to travel mode, according to embodiments of the invention;

FIG. 7A is a graph depicting the required runway length for an HCAV taking off with and without the assistance of motorized wheels as a function of the tilt angle of the DFs, according to embodiments of the invention;

FIG. 7B is a graph depicting the energy required for an HCAV to takeoff as a function of the DFs angle, with and without assistance of motorized wheels, according to embodiments of the invention;

FIG. 7C, is a graph presenting the difference between the energies of the two graphs of FIG. 7B, according to embodiments of the invention;

FIG. 8 is a graph comparing the energy consumed by an HCAV during takeoff, transition and climb in VTOL and in STOL takeoff modes, according to embodiments of the invention;

FIG. 9 is a graph depicting the altitude gained from takeoff versus distance when taking-off in VTOL (dashed line) mode and in STOL (full line) mode, according to embodiments of the invention;

FIG. 10A depicts a cover system of a fuselage DF, in four views, according to embodiments of the invention;

FIG. 10B depicts a schematic cross section illustration of a duct assembly for DFs, according to embodiments of the invention;

FIG. 11 is a schematic illustration of a replaceable shock absorbing system, according to embodiments of the present invention;

FIG. 12 depicts the energy demand for each flight phase of an HCAV;

FIG. 13 is a graph showing the amount of gained energy during descent as a function of the air flow velocity through the DFs, according to embodiments of the invention; and

FIG. 14 is a schematic flow depicting a process for calculating and controlling the physical flight operators associated with the autonomous or manual control of the HCAV, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

General considerations: A vehicle according to embodiments of the present invention is designed to provide real door to door transportation, with no required connection considerations between ground and aerial transportation—just one vehicle driving normally as a car and flying as an aircraft. This vehicle may retain the same freedom as using one's own car nowadays and may extend the envelope of operation of transportation by flying above the jammed roads. Using this vehicle may maintain the benefits of the suburban communities and mega cities coexistence. The vehicle described herein below will be denoted throughout this description also “HCAV”.

T/O considerations: The HCAV is designed and built to take-off and land vertically or by using a very short runway. The lift for the vertical take-off and landing is provided by a ducted fans system. Using an enclosed rotor (=ducted fan) configuration increases the general safety around the vehicle and improves its capabilities to fly safely in an urban environment. The ducted fan configuration also provides high lift for vehicle captured area. The ducted fan rotors may allow the HCAV to eliminate the operating limitations applicable to open rotor vehicles in an urban environment, such as limitations due to the trees and transmission lines in the vicinity of landing zones.

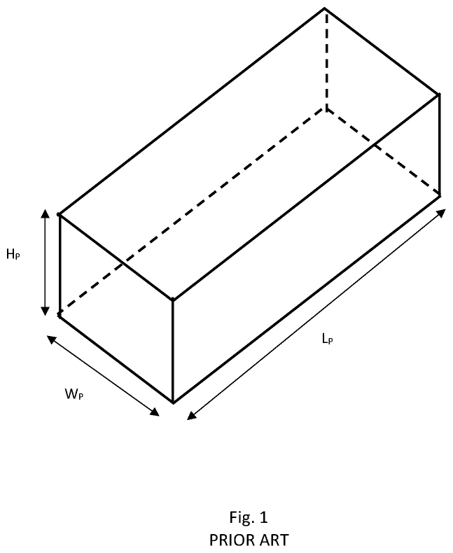

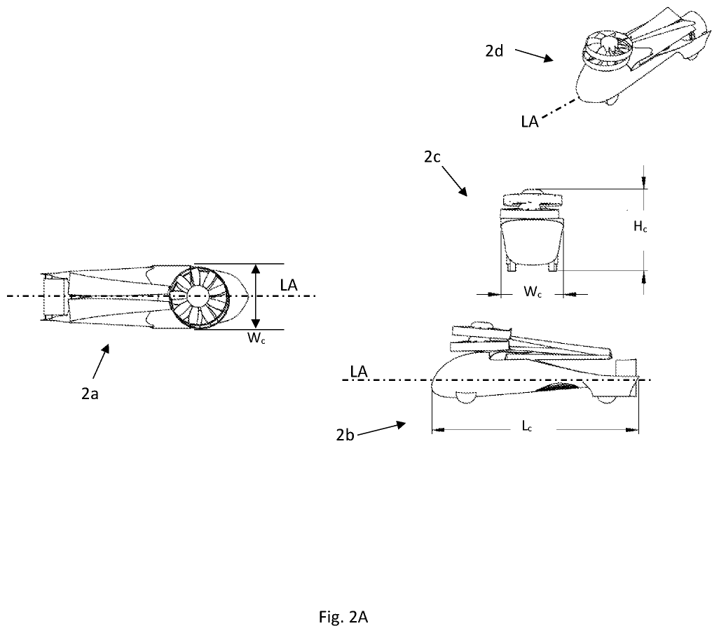

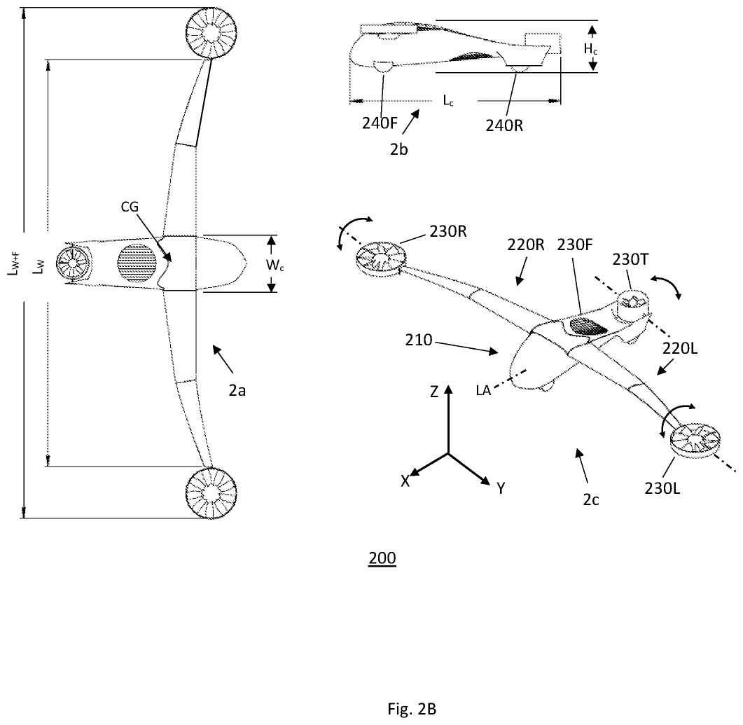

Size considerations: The HCAV vehicle may be used as a licensed road-licensed car, meaning its size and safety regulation requirements are applied. This size constrains allow the vehicle to be parked in a typical household garage and parking lots. The road car safety regulations are met, and therefore the HCAV vehicle is road-certification ready for operation on public roads including highways. Reference is made to FIG. 1 depicting cubical dimensions length, width and height representing dimensions a licensed road car should be able to fit in: L_{P}, W_{P}, H_{P} (length, width and height respectively) and to FIGS. 2A and 2B which present a schematic illustration of a HCAV 200 in “road” position and in “flight” position, respectively, according to embodiments of the invention, in three standard elevations (top (2a), side (2b) and front (2c) and in isometric view (2d)) which define the HCAV maximal external dimensions L_{C}, W_{C}, H_{C} (length, width and height respectively). It would be apparent that the vehicle design depicted in FIGS. 2A and 2B is for illustration of the external main measurements of the vehicle, for which the following holds:

L_{C}<L_{P}, W_{C}<W_{P}, H_{C}<H_{P}

for the overall dimensions of the vehicle. For example, the following main dimensions of the HCAV may be, in some embodiments:

L_{C}≤12000 mm

W_{C}≤3000 mm, and

H_{C}≤4000 mm

In the various views of FIG. 2B some main assemblies of HCAV 200 are shown. HCAV 200 comprises main body (fuselage) 210, two foldable wings 220L and 220R, four ducted fans (DFs): left DF 230L, right DF 230R— each tiltably disposed at the outmost end the respective wing, fuselage fixed DF 230F and tiltable tail DF 230T. Also shown are front wheels assembly 240F and rear wheels assembly 240R. A detailed description of these assemblies is found herein below.

In some embodiments the HCAV is adapted to carry two passengers, and in other embodiments is adapted to carry four or more passengers.

Lift Requirements: The entire lift needed for the Vertical take-off or landing, the thrust needed to take-off or landing using a very short runway, and the thrust needed for the transition to and fly at level cruise flight may be provided by a set of ducted fan (DF) based thrust system. The thrust by ducted fans is preferred due to improved mechanical-aerodynamic efficiency and improved safety (enclosed and protected fan's blades). Ducted fan has typically improved aerodynamic efficiency—the ability to produce higher lift (thrust) compared with the open free flow blades. At least some of the ducted fans in a HCAV are tiltable to enable providing thrust that may be directed between an angle that is substantially parallel to the direction of a longitudinal axis LA (FIG. 2A) of the HCAV, usable in level flight, and an angle substantially perpendicular to LA, usable during take-off or landing.

The configuration of the HCAV depicted in the embodiment of FIGS. 2A and 2B has certain main design features. Wings 220R, 220L are foldable to allow conversion to a road compatible form of HCAV 200, as is explained in detail herein below. The wingtip DFs 230R, 230L are rotatable about the Y axis (the transversal axis of HCAV), to enable use of the thrust they produce both during vertical takeoff or landing and during level flight, as is explained in detail herein below. Fuselage DF 230F is disposed behind the passenger cabin and behind the CG of HCAV. DF 230F is not tiltable and is capable of providing thrust only in a direction parallel to the Z axis, as is explained in detail herein below. Tail DF 230T is disposed at the rear part of HCAV 200 and is tiltable to enable use of the thrust they produce both during vertical takeoff or landing and during level flight, as is explained in detail herein below. HCAV 200 has a road wheels assembly comprising front wheels assembly 240F and rear wheels assembly 240R, adapted to drive HCAV 200 when in road form, including motorizing, steering and breaking and adapted to assist during takeoff by providing forward additional during when HCAV 200 is in takeoff run on a runway.

As seen in FIGS. 2A and 2B, the maximal diameter of the different DFs may not exceed the maximal allowed width of the HCAV in order to comply with road vehicle regulations. Accordingly, the location of the ducted fans in respective dimensions and the different operational modes (Flight, VTOL and Drive) are shown.

It would be apparent that the total number of DFs, the number of sub-group of tiltable DFs and the location of each DF is subject to specific design and to its associated constrains and requirements such as the number of passengers, the total net weight, the service flight distance, whether runway is available or not, and the like. The detailed description in this specification relates to a four DF embodiment adapted to carry up to 4 passengers.

Number of Fans: The number of fans is driven by the dimensions of the vehicle. Due to road regulations the width and the height of the HCAV are limited. The length is a variable and subject of change. The change is driven by the maximum take-off weight and the dimensions of the payload. The maximum take-off weight drives the overall DF area, which should be large enough to generate enough thrust to maneuver the vehicle safely. The necessary thrust is given by the thrust to weight ratio. The dependency of the DF area in regard to the thrust is given by the DF disk loading. The disk loading is the ratio of the thrust to the disk area. That means the smaller the disk area the higher the disk loading. An increased disk loading means an increase in required power, which is given by the power loading. The power loading is the ratio between thrust to required power.

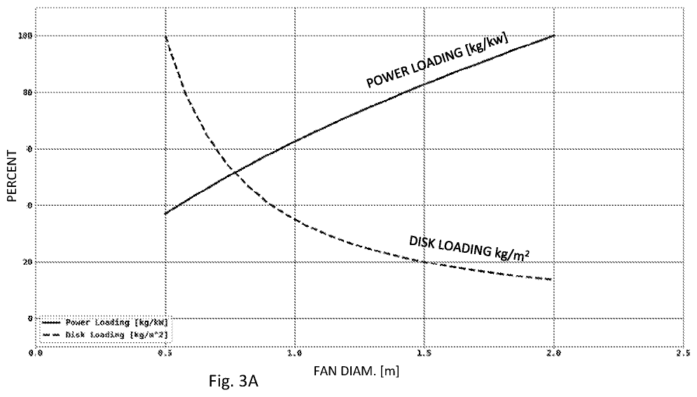

Reference is made to FIG. 3A which depicts a graph of dependency of disk loading and power loading on DF diameter. The dependency of the power loading and the disk loading in regard to the fan diameter is given. The power loading shows the thrust produced per kW while the disk loading shows the thrust per fan area. In order to get the most thrust of DF the maximum disk loading is chosen. The optimum in terms of power can be found at the maximum of the power loading curve and a large diameter is chosen. In order to get the best power to thrust ratio the point of intersection of both curves is taken.

The HCAV is designed to meet certain goals and therefore the propulsion system density and the HCAV mission range drive the DF diameter as limited by the vehicle width. To enable VTOL, the HCAV needs the most thrust per kW in order to minimize the weight of the propulsion system. Thus, the DF diameter is maximized within the constraints given by the vehicle dimensions. With increasing propulsion density the fan diameter, as driven by the best power-to-thrust ratio, will decrease. More but smaller fans may be incorporated in an HCAV with propulsion system having increased propulsion density.

Reference is made to FIG. 3B, which is a graph depicting the dependency of the required power for takeoff on the width of the vehicle as function of maximum take-off weight (MToW) and the type of source of electrical power — fuel cell or battery. The horizontal lines are the available power given by different propulsion systems. The “Hybrid Inst.” Horizontal line represents the performance of a hybrid system incorporated in a HCAV according to embodiments of the invention. The curved lines represent the power demand in accordance to the vehicle size for different maximum take-off weights

(MToW). The DF diameter is directly proportional to the vehicle width and is given by the following equations:

D_{Fuselage fan}=k₁*width_{Vehicle}

D_{Back fan}=k₂*D_{Fuselage fan}

D_{Wing-tip fan}=k₃*D_{Fuselage fan}

The factors k₁ to k₃ are chosen to not exceed the maximum width, if the

HCAV is in driving mode. That means, in order to build a smaller vehicle with a similar MToW figure the power of the propulsion system has to be increased or the available disk area must be larger. Therefore, with the reference vehicle design (MToW=2000 kg) the DF area has to be extended, which due to the width restriction is only possible by increasing the number of DFs. With increasing power supply of the power unit, e.g. due to propulsion development, a higher disk loading and lower power loading, respectively, can be installed and the current design can be shrunk to meet more strict road regulations in different countries.

TABLE 1

| | | | | | Trust | Fan | | |
|---|---|---|---|---|---|---|---|---|
| | | | CG − X | CG − Y | max | Diameter | | Power |
| DF ID | X [m] | Y [m] | [m] | [m] | [N] | [m] | FoM | [kW] |
| Wing-Tip (R) | 1.3 | 8.15 | 1.3 | −8.15 | 7991.56 | 1.80 | 1.1 | 260 |
| Wing-Tip (L) | 1.3 | 8.15 | 1.3 | 8.15 | 7991.56 | 1.80 | 1.1 | 260 |
| Fuselage | 4 | 0.0 | −1.4 | 0.0 | 6756.06 | 1.4 | 1.1 | 260 |
| Back | 6 | 0.0 | −3.4 | 0.0 | 5755.89 | 1.10 | 1.1 | 260 |

Where X is the relative longitudinal location of the DF, Y is the relative transversal location of the DF, and FoM is Figure of Merit/FoM in this regard characterizes the respective DF relative to its alternatives, and is defined: the diameter of the fan divided by the exit area times the thrust coefficient to the power of ⅔ divided by the power coefficient.

Wing-tip DFs: Tilting DFs 230R, 230L are attached to the wing tips of wings 220R, 220L respectively. This configuration enables the HCAV to takeoff, hover and land like a helicopter and fly forward like an airplane. This enables using any arbitrary location for takeoff and landing combined with enhanced flight range and speed. The wingtip DFs are tiltable around the pitch-axis (usually the Y-Axis) of the vehicle's coordinate system. An additional advantage of this configuration is a positive aerodynamic effect. The fans in the currently described embodiment are rotated in a direction to produce a counter rotating vortex in regard to the unavoidable wing tip vortex. This reduces the drag of the wing by damping the energy loss produced by the wing tip vortex.

The position at the wing tip has another advantage by utilizing its long Y distance to the center of gravity (CG). This can be used in maneuvering known as thrust vectoring. The wingtip DFs are also part of the stability control of the HCAV. The above described design of the HCAV makes it necessary to actively control the Pitch, Roll and Yaw (PRY) stability. In order to meet this requirement the flight control computer system has to apply an appropriate reaction to a measured momentary current position and rotation of the HCAV (AoA, Roll, and Yaw position) and apply corresponding control commands to the wingtip DFs as well as to the tiltable rear DF. A communication system provides control commands from the flight computer system to the actuators driving the tilt rotation and the momentary thrust of the DFs. It also includes the mechanism to establish the communication between the flight computer and the actuators/motors during the folding procedure and/or in drive mode (folded wings).

As discussed above, the maximal wings DFs diameter is limited by the width of the HCAV and the shape of the wing, in order to enable secure stowing/folding of the wings in drive mode. It is maximized to create the necessary lift for vertical take-off.

Fuselage DF: In order to generate enough thrust to lift the HCAV off the ground and to ensure safe vertical landing a large DF 230F is installed in the back of the fuselage, behind the CG of the HCAV with respect to the level flight direction. The position is chosen to generate a negative pitching moment (i.e. increased thrust causes increased nose down effect), which is necessary to stabilize an air vehicle of this size. DF 230F is incorporated in the fuselage and comprises a controlled cover to enable covering it during level flight and by this to minimize drag when not in use. Another advantage of this particular position is to utilize the Coanda-effect. The Coanda-effect describes the tendency of a fluid to stay attached to a convex surface. The specific location of DF 230F and the thrust it produces when it is operated generates an airflow around the fuselage which strengthens the generated lift. This added lift enables reduction of the energy required during the VTOL flight phases.

Rear/aft (tail) tiltable DF: The size of the rear DF 230T is chosen to fit in the tail structure of the vehicle and to optimize the lifting capabilities. During takeoff mode the fan is turned in the −Z direction so to aim its thrust parallel to the gravity direction, and by that the thrust it produces is perpendicular to the longitudinal axis of the HCAV. During level flight DF 230T is turned to provide thrust that is substantially parallel to the vehicle's longitudinal axis LA, used as a pusher DF to provide additional flight thrust.

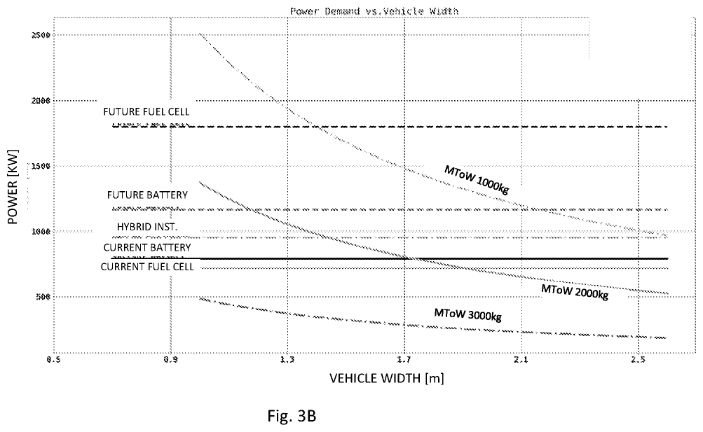

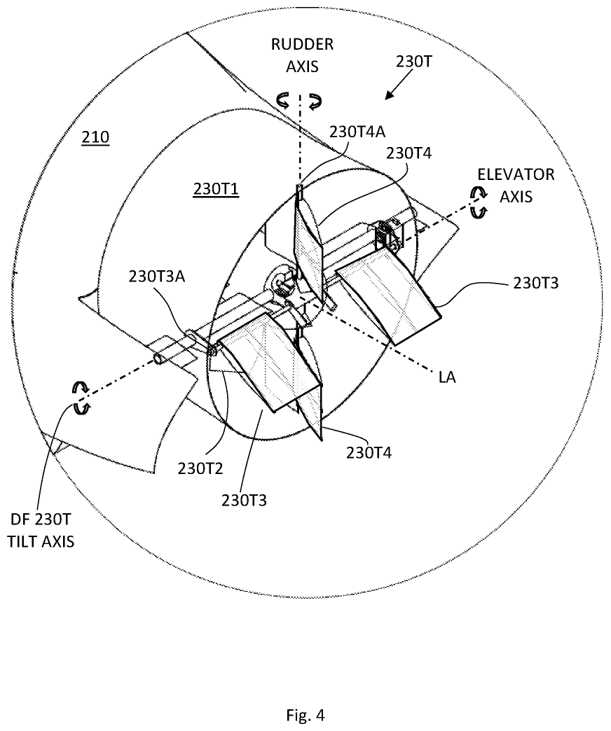

Rear tiltable DF 230T assembly incorporates two independently moving fins, which are used as rudder and elevator respectively. Reference is made to FIG. 4, which is a schematic partial enlarged isometric illustration of tail DF 230T assembly, according to embodiments of the invention. Tail DF 230T assembly comprises duct 230T1 which houses in it fan 230T2. Behind fan 230T2 are disposed elevator fins 230T3 and rudder fins 230T4, which are installed with a longitudinal axis 230T3A and 230T4A, respectively, allowing controlling the angle of direction of each of them with respect to a neutral direction which places the fins in plane parallel to longitudinal axis LA. Fins 230T3 and 230T4 are presented with their aerodynamic surfaces are partially transparent to show details behind the fins. The entire assembly DF 230T is rotatable about the DF 230T tilt axis. Within the 230T assembly each of fins 230T3 and 230T4 are rotatable independently of each other, about fin rotation axes 230T3A and 230T4A, respectively to enable control of HCAV tilt and yaw, respectively. The actuators controlling the tilt of 230T assembly, the rotation angle of elevator fins 230T3 and of rudder fins 230T4 are not shown to not obscure the drawing. This configuration enhances the effectiveness of control surfaces of elevator fins 230T3 and rudder fins 230T4, as shown by NASA studies, by utilizing the higher flow velocity of DF 230T around the surfaces of fins 230T3, 230T4.

In some embodiments in order to minimize the drag and maximize the body lift during straight flight, the inlets and upright nozzles of the ducts may be covered.

A basic embodiment is described herein below, however, as explained above, many other embodiments may fall within the ambit of the invention.

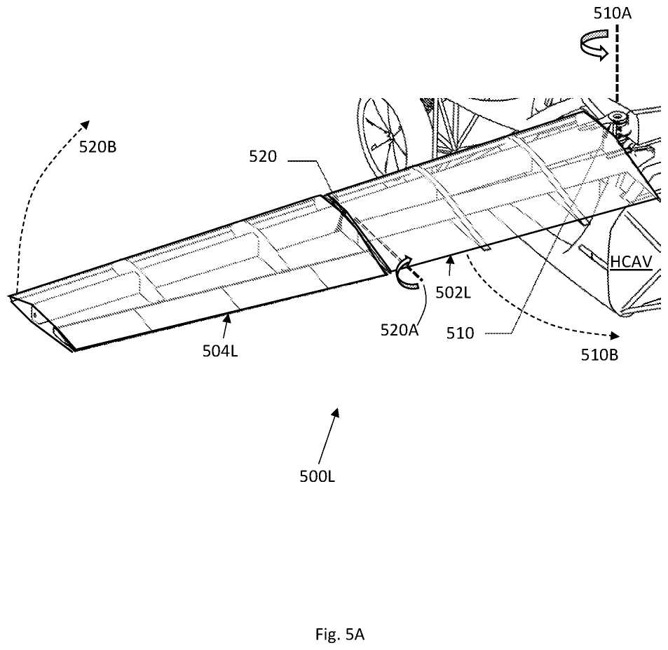

Wing folding mechanism: The folding mechanism of wings of the HCAV, such as wings 220R, 220L (FIGS. 2A, 2B) is separated into two parts. Reference is made now to FIG. 5A, which is a schematic illustration of inboard folding mechanism 510 (also denoted wing root folding mechanism) and outboard folding mechanism 520 (also denoted mid-wing folding mechanism) of left wing 500L, according to embodiments of the invention. Each of the HCAV wings may comprise two main parts. The wing depicted in FIG. 5A is the left wing. The right wing is a mirror picture of the left wing. The outboard mechanism to fold the outboard wing 180 degrees over the inboard wing and an inboard mechanism to turn the whole wing 90 degrees over the fuselage. Left wing 500L may be formed by two main parts. The inner main part 502L may be pivotally connected to the fuselage of the HCAV by inboard folding mechanism 510, adapted to enable folding the left wing 500L from a deployed state backwardly about pivot line 510A. The rotational movement of wing 500L about pivot line 510A is substantially in a plane parallel to the longitudinal axis LA as depicted by dashed arrow 510B. A detailed description of inboard folding mechanism 510 is made in FIG. 5B and the associated description.

The outer main part 504L of left wing 500L may be pivotally connected to inner main part 502L by outboard folding mechanism 510, that is adapted to enable folding the outer main part 504L part with respect to the inner main part 502L from a deployed state upwardly about pivot line 520A as depicted by dashed arrow 520B. A detailed description of outboard folding mechanism 520 is made in FIG. 5C and the associated description.

Reference is made now to FIG. 5B, which is a schematic illustration of inboard folding mechanism 550L, according to embodiments of the invention. In view “a” of FIG. 5B partial view of left wing 500L is shown with main beam 530L and aft beam 532L. Main beam 530L is connected via inboard folding mechanism to HCAV fuselage beam 5100 of HCAV 5000. View “b” of FIG. 5B is a partial enlarged view of folding mechanism 510. Left wing 500L is connected via its main beam 530L to folding mechanism 510 and is adapted to rotate about pivot 511 of folding mechanism 510. Folding mechanism 550L includes turning hinge gear, a rotary actuator and two separate locking mechanisms. Fuselage 5000 of HCAV is connected to folding mechanism 510 via beam 5100. The details of connection of beam 5100 to folding mechanism 510 are not shown to eliminate obscuring the drawing. Folding mechanism 510 comprises spur gear 512L adapted to be rotated about rotation axis 510A by means of rotational actuator 5520L that is mechanically connected to beam 5100 or other close structure element of fuselage 5000. Rotational actuator may be, for example, an electric motor.

Two locking mechanisms are necessary to secure the wing in flight mode as well as in drive mode. The flight mode mechanism must be strong enough to lock the wing securely and to withstand the forces of all flight phases, including VTOL and emergency maneuvers. The locking mechanism comprises automated lock pin 5300 that is adapted to secures the rear beam 532L in place with respect fuselage rear beam 5100L. The main beam 530L is locked by the front hinge including the spur gear. Locking mechanism may further comprise shear pin 5400. In drive mode the external forces acting on the wing are negligible, therefore the rear locking mechanism, that is designed to secure the wings in drive mode may be made to stand smaller forces and therefore may be lighter than the one for flight mode. It is necessary to prevent the wing from unfolding during normal driving conditions. It is the same principle as the flight mode locking mechanism. The locking pins can be installed sideways, as seen in FIG. 5B, or up/downwards. The material and dimensions must be chosen regarding the weight and forces expected to be acting on the wing in the different modes.

Reference is made now to FIG. 5C, which is a schematic illustration of folding mechanism 520 shown with regard to a right wing, according to embodiments of the invention. Folding mechanism is adapted to enable folding/unfolding of outer main part 504R of wing 500 onto/from inner main part 503R about folding pivot 5520. View “a” of FIG. 5C depicts a partial view of folding mechanism 520 in an isometric view shown from the rear part of the HCAV. Main beam 530R of inner main part 503R is pivotally connected to main beam 540R of outer main part 504R of right wing 500R via a triangle shaped hinge 5510 adapted to enable 180 degrees folding about pivot 5520. Pivot 5520 is located at one vertex of triangle hinge 5510. First linear actuator 5530 is pivotally connected between rear pivot 5530A connected to main beam 530R and pivotally to a second triangle vertex 5510A of hinge 5520. Second linear actuator 5540 is connected to main beam 540R via pivot 5540A and to pivotally to third triangle vertex 5510B of hinge 5510. When wing 500R is in unfolded state it may be secured against undesired folding by lock pins 5560. In order to fold right wing 500R actuators 5530 and 5540 may be operated to extend thereby pivot point 5510A away from pivot 5530A and pivot point 5510B away from pivot 5540A, thereby causing outer main part 504R to fold upwardly about pivot 5520 as depicted by the dashed-line portion of vie “b” of FIG. 5C. For double redundancy two sets of actuators may be installed, one on each side of main beam 530R. 540R, respectively. During folding the lock pins 5560 are automatically removed (inside or outside direction),

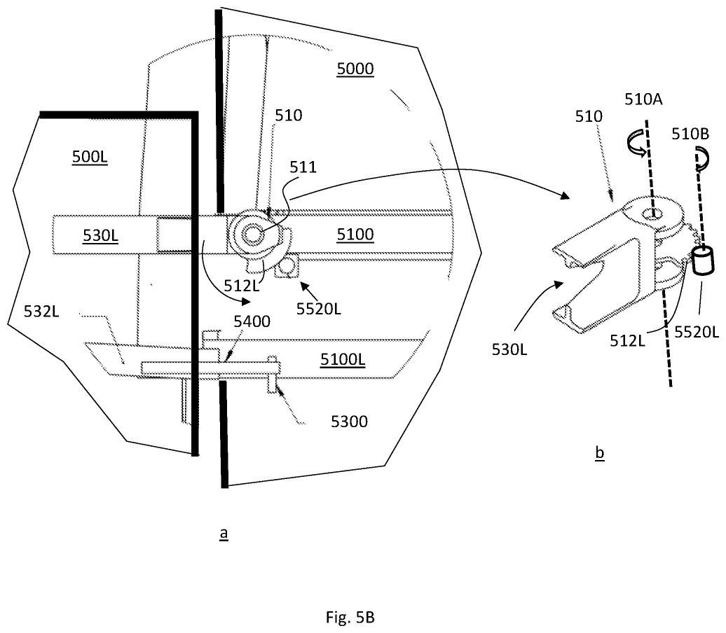

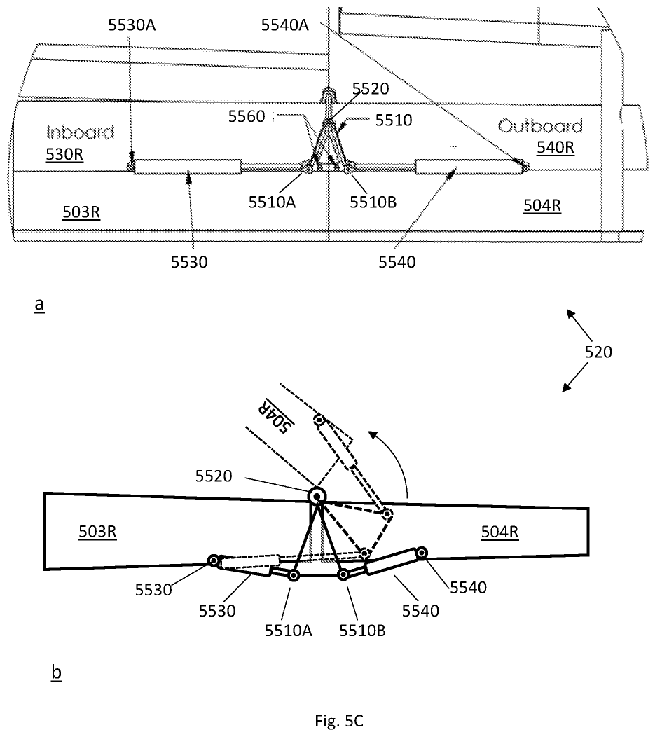

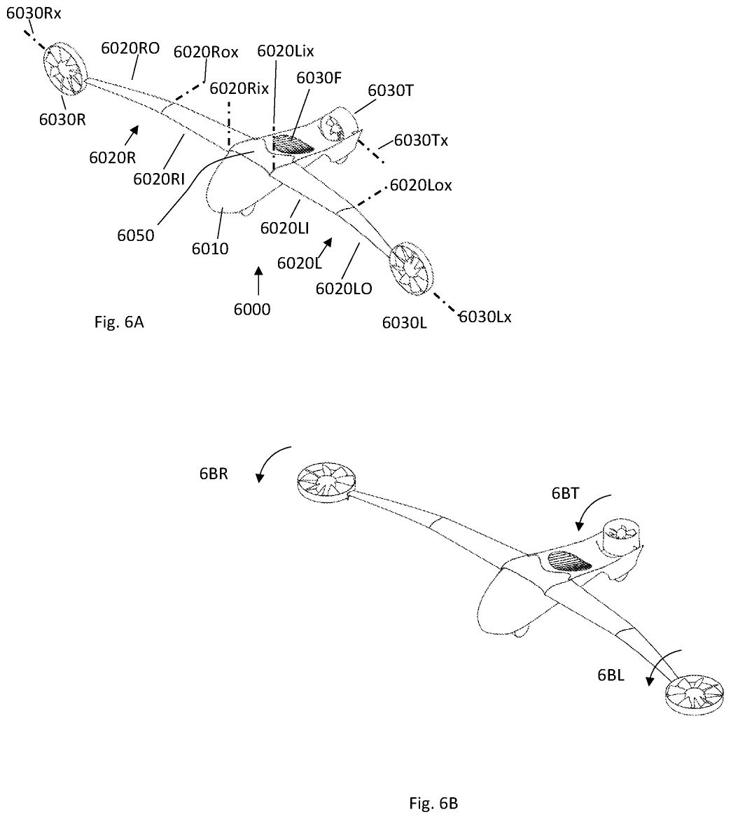

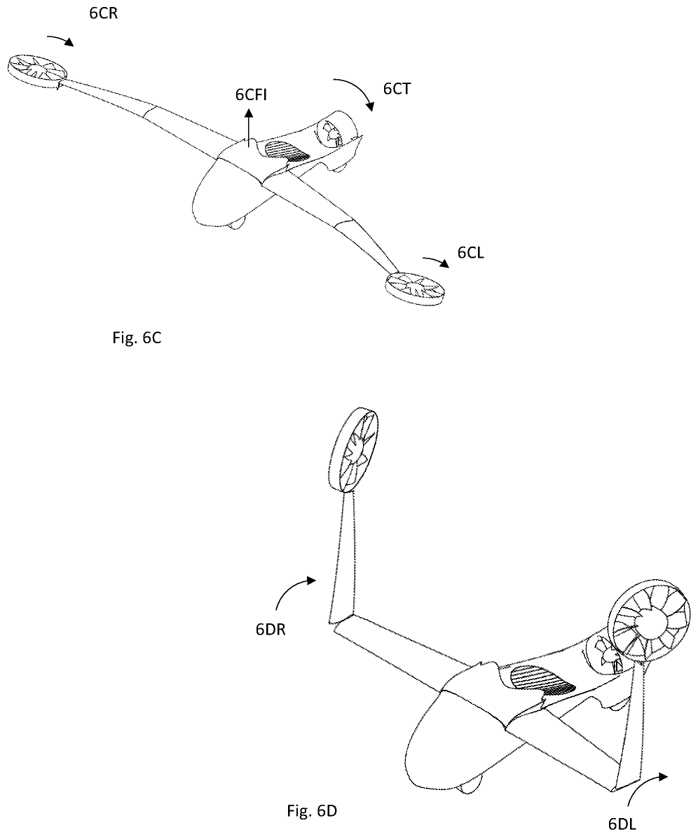

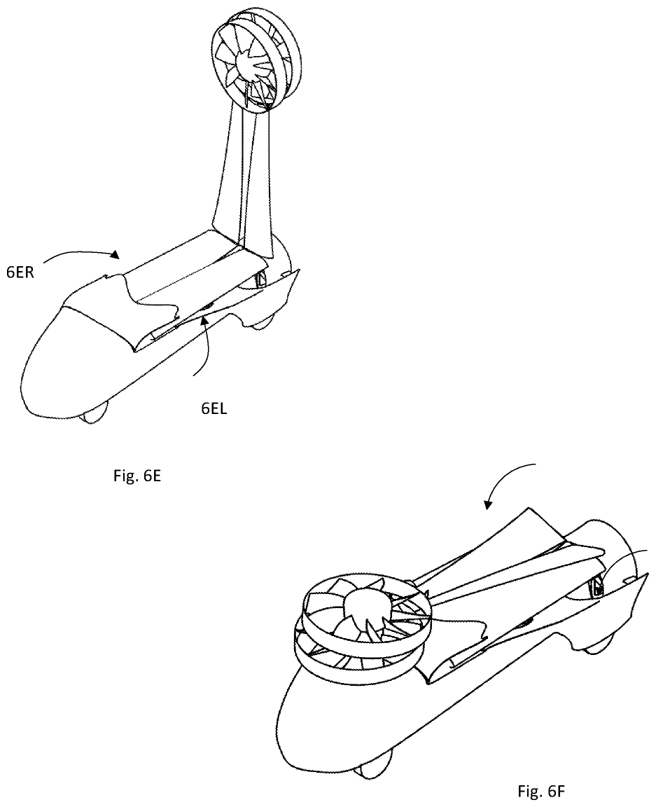

Wings folding—transition from Flight to Drive: transition of the HCAV from flight form to drive form involves a sequence of several operations and may not be performed during flight and is not recommended to be performed during driving. Reference is made now to FIGS. 6A-6F, which depict six stages of transition of HCAV 6000 from flight form to drive form, according to embodiments of the invention. HCAV 6000 is presented in a simplified drawing and comprises fuselage 6010, right and left wings 6020R and 6020L, wings tip DFs 6030R and 6030L, fuselage DF 6030F and tail DF assembly 6030T and stowed wings fairing aerodynamic surface 6050. Wings 6020R and 6020L are adapted to fold their respective main inner and outer parts (6020RI, 6020RO, 6020LI, 6020LO) with respect of the outer main part to the inner main part about folding axes 6020Rox, 6020lox, respectively, as explained herein above in detail. Folded wings 6020R and 6020L may be rotated to stowed position about their stow/deploy axes 6020Rix and 6020Lix, respectively, as explained herein above in detail. Wings tip DFs 6030R and 6030L may rotate about their tilting axes 6030Rx and 6030Lx, respectively, as explained herein above in detail. Tail DF 6030T may rotate about its tilting axis 6030Tx, as explained herein above in detail. Fairing aerodynamic surface 6050 may be turned from is flight (closed) position upwardly about a front axis (not shown), to transit from aerodynamic form adapted for the flight stage, to open form adapted to allow stowing of the wings when changing to drive form.

The next five stages of transition from flight dorm to drive form, as depicted in FIGS. 6B-6F, are not annotated to minimize obscuring of the drawings. The respective changes are presented by arrows showing the movement/rotation that took place to get to the described form from the previous form. Each of the movements/rotations are done about their respective axes, as described with respect to FIG. 6A.

In the flight position of FIG. 6A, HCAV 6000 is in flight mode. Wings 6020R and 6030L are fully deployed and secured in the deployed position. DFs 6030R, 6030L and 6030T are directed forward to provide flight thrust. Fairing aerodynamic surface 6050 is closed to provide smooth aerodynamic surface.

In FIG. 6B HCAV 600 is in hover form. Wings 6020R and 6030L were not changed and they are fully deployed and secured in the deployed position. DFs 6030R, 6030L and 6030T were tilted to direct their thrust vertically down as depicted by arrows 6BR, 6BL and 6BT, respectively. Fuselage DF may be turned on however its position is not changed. Before fuselage Df is turned on its covers (not shown) that were closed during flight in order to maintain the best aerodynamic profile, must be opened.

FIG. 6C depicts the form of HCAV 6000 after landing. Wings 6020R and 6020L are still fully deployed, yet their secure mechanism may now be freed. Wings tip DFs 6030R and 6030L are rotated slightly in a direction opposite to the previous rotation as depicted by arrows 6CR and 6CL in order to position them in the right angle for stowing. Tail DF 6030T is turned back to face forward, as depicted by arrow 6CT. Fairing aerodynamic surface 6050 is opened as depicted by arrow 6CFI, to make room for the wings that will be stowed in next stages. The covers of the fuselage DF may be closed, to provide protection to the DF against FODs.

FIG. 6D demonstrates first stage of folding of the outer parts of wings 6020R and 6020L upwardly, as depicted by arrows 6DR and 6DL. Prior to this operation the security mechanism must be released.

FIG. 6E demonstrates second stage of folding of wings 6020R and 6020L by rotating them towards the fuselage of HCAV 6000, as depicted by arrows 6ER and 6EL.

FIG. 6F demonstrates the last stage of transition from flight form to drive form. The outer parts of the wings complete now their folding from a substantially right angle to a substantially 180 degrees angle, which brings the wings tip DFs 6030R and 6030L close above the front end of the HCAV fuselage. When this rotation has been completed and securing means have been operated, HCAV 600 is in a form ready to drive on a road.

Reference is made now to FIG. 6G, which is a schematic flow diagram depicting a process of changing the form of the HCAV from flight mode to travel mode, according to embodiments of the invention. After landing all titlable DFs are directed to vertical position (block 602). When fans are turned off wing-tip DFs are directed to an angle of stow position and rear DF is directed to horizonal position (block 604). At this stage locking mechanisms of mid-wing mechanisms are unlocked and outer main parts of the wings are folded up to vertical position (block 606). Locking mechanisms of wing root folding mechanisms are unlocked and the wings are rotated backward to stow position (block 608). In the last stage outer main parts of the wings are folded at the mid-wing mechanism over the inner respective parts of the wing to a stow position and all folding mechanisms are securely locked in the stow position (block 610).

Short T/O and Landing: an HCAV according to embodiments of the invention, such as HCAV 200 or HCAV 6000 are adapted to takeoff or land on a very short runways, when extra weight and/or extended range need to be addressed. It is known that vertical takeoff or landing consumes more energy and/or supports lighter weight compared to takeoff/landing by running on a runway. Naturally, a shorter runway (up to a certain upper limit) provides less gain of lift weight or smaller saving of energy, compared to a longer runway. Further, if a runway is needed for HCAV the advantage of taking-off/landing virtually anywhere is eliminated. In order to minimize the runway length, the rotating DFs are utilized during the different flight phases. The exact DFs positioning and rotating is determined according to embodiments of the invention.

The novelty of this idea is to actually use the tilting of the fan to provide not only thrust in one direction, horizontal or vertical, but to set the thrust direction so that it is divided to a vertical force and a horizontal force. By this, enough speed can be gained to ensure the lift off with the wing and at the same time the required runway length may be minimized by enhancing the lift with the vertical vectored thrust of the fan.

According to another embodiment the short take-off system can utilize the wheels driving capabilities to even further reduce the takeoff power demand. In this case the wheel drive system can be used to accelerate the HCAV to its maximum driving speed and add the DFs thrust at the point of best performance figure until the DFs fully take over. According to some embodiments the HCAV control system is adapted to switch between the wheel drive system and free spinning wheels during the acceleration with the

DFs. Accordingly an HCAV according to embodiments of the present invention may be provided with at least one motorized wheel, preferably two wheels that may be operated during takeoff running, in order to assist in the first stage of acceleration and speed gaining, when run takeoff is used. Since an HCAV according to embodiments of the present invention is provided with motorized wheels for use when in drive mode of operation, the motorized wheels system may be adapted to be operated during takeoff run. It is expected that at the first stage of the speed gained during takeoff run the contribution of the motorized wheels to the overall acceleration will be substantive, thereby the motorized wheels system may be utilized to shorten the length of required runway and or to increase to overall weight at takeoff when using runway.

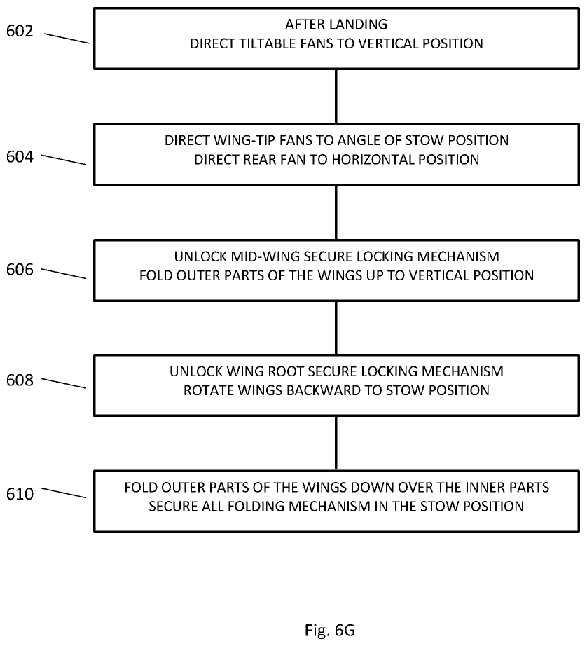

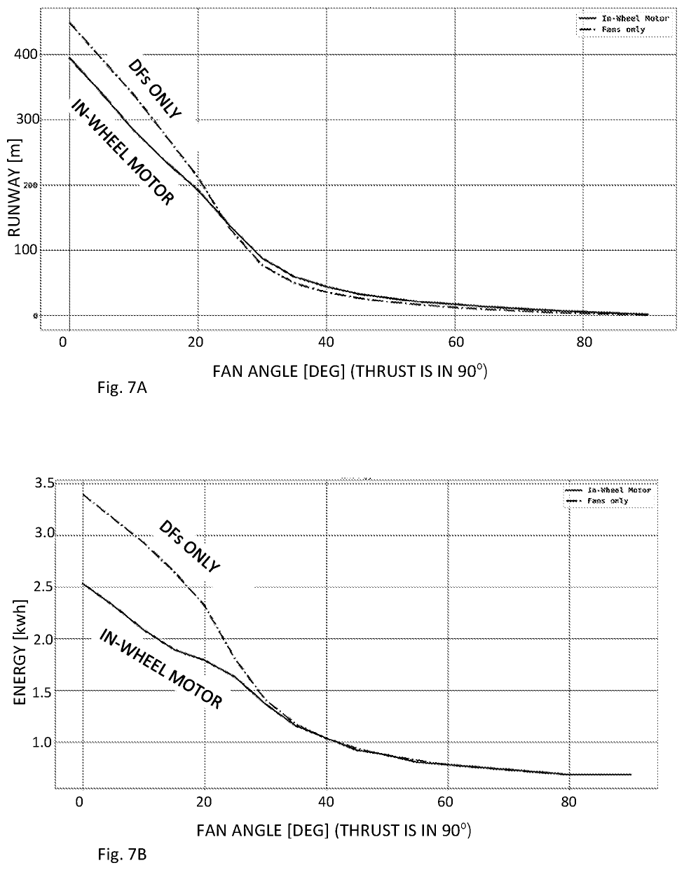

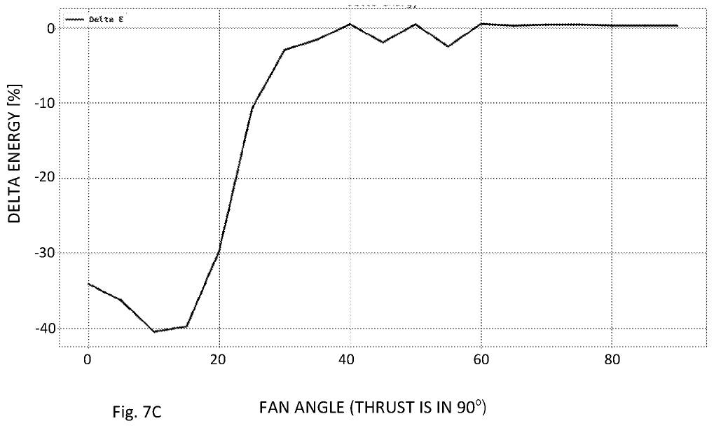

Reference is made now to FIG. 7A, which is a graph depicting the required runway length for an HCAV taking-off with and without the assistance of motorized wheels as a function of the tilt angle of the DFs, according to embodiments of the invention. In these calculations the take-off phase is finished when an altitude of 20 meters is reached. This is done to make it comparable to a vertical take-off. Especially with low fan angles (i.e.—high thrust angle) the runway can be shortened by 15%. At higher fan angles the runway becomes too short for the in-wheel motor to take full effect. Nevertheless, the runway length can be decreased significantly using the tilting fans. For example, an HCAV can take-off and climb to an altitude of 20 meters within 25 meters of runway utilizing a fan angle of 70 degrees (thrust is directed upward 20 degrees).

Reference is made now to FIG. 7B, which is a graph depicting the energy required (in KWH) for the HCAV to takeoff as a function of the DFs angle, with and without assistance of motorized wheels, and to FIG. 7C, which is a graph presenting the difference between the energies of the two graphs of FIG. 7B, according to embodiments of the invention. The required energy is calculated for a take-off with the in-wheel motor and without. Especially at the lower DFs angle (higher thrust angle) the in-wheel motor decreases the energy demand by over 40%. With increasing DFs angle the energy savings decreases until a fan angle of 45 degree (thrust is directed 45 degrees upwardly), where the energy demand becomes equal, as shown in FIG. 7C. It should be noticed that during the vertical take-off the power demand seems very low. This is due to the short time it needs to get to level of 20 meters. However, the most energy demanding flight phase is the transition from hover to level flight, which is not necessary, if the HCAV does a runway takeoff. In fact the transition phase demands as much as three times the energy of the conventional take-off without the in-wheel motor and 3.5 times as much as utilizing motorized running acceleration approach. Therefore, the in-wheel motor saves a significant amount of energy during the take-off.

The above calculations are done by solving the physics equation:

F=m(t)*a

With F being the force vector in horizontal and vertical direction. This includes, but is not limited to the aerodynamic forces, the in-wheel motor forces and the thrust given by the DFs at a certain RPM. The mass m(t) is a function of time which in general is needed since fuel is burned and therefore the mass decreases over time. However, during takeoff this is not taken into account because of the short time period. The acceleration vector a is the outcome of the calculations. The horizontal acceleration is used to accelerate the HCAV forward, while the vertical part lifts the HCAV in the air. Certain input parameters and boundary conditions are taken into account. VTOL versus STOL: an HCAV according to embodiments of the invention is designed as a drive and fly vehicle and is therefore capable of taking-off from a runway. This unique feature in urban air mobility (UAM) is able to save energy during take-off by utilizing the in-wheel motor and the wing to perform a short take-off. The energy is calculated for take-off, in the case of a vertical take-off , the transition and the climb to its intended flight level of FL40.

The vertical takeoff and the runway takeoff consume a similar amount of energy in the initial phase. During vertical takeoff the HCAV must be accelerated in vertical direction and during a runway takeoff the HCAV has to be accelerated in horizontal direction up to the 1.3 times the stall velocity. In addition, in VToL mode, upon reaching 20 m altitude, the HCAV has to be accelerated horizontally until it reaches 1.3 times the stall velocity. This phase is called transition phase. During the transition phase the tiltable DFs are rotating around their center axis. This is a critical phase, since the thrust used to accelerate the HCAV in vertical direction is then gradually redirected in the horizontal direction. According to a design requirement the HCAV is not supposed to dip, meaning losing altitude, during that phase. In conclusion, this phase is a costly endeavor in terms of energy. This phase is only necessary during vertical take-off and landing respectively.

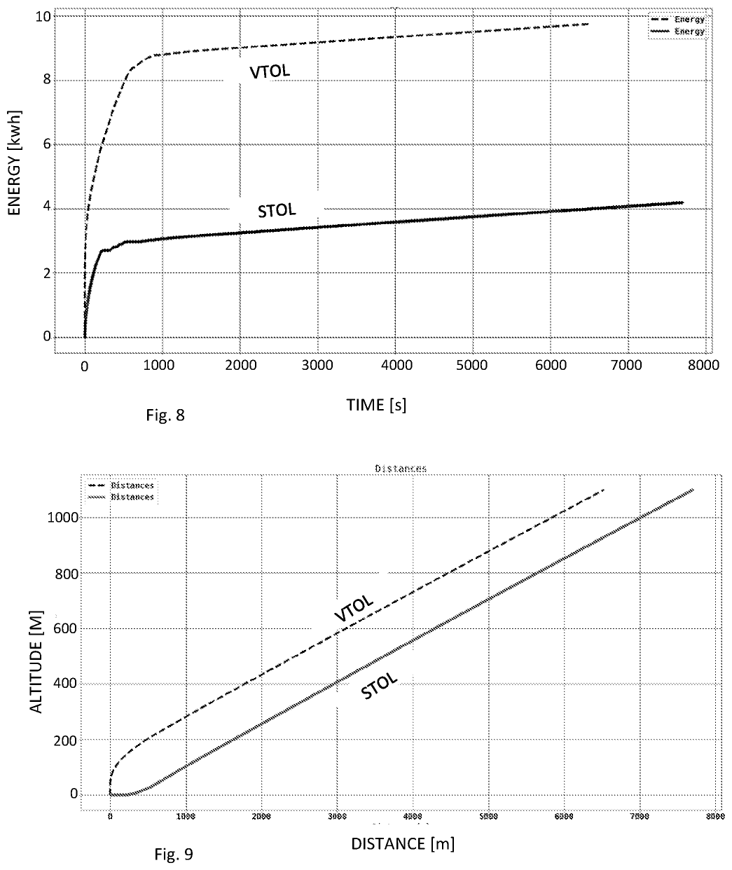

The difference in that phase is seen in FIG. 8, which is a graph comparing the energy consumed by a HCAV during takeoff, transition and climb in VTOL and in STOL takeoff modes, according to embodiments of the invention. The dashed line is the typical energy used during a vertical take-off and climb to FL (flight level) 40 and the full line shows the take-off and climb when the short takeoff capabilities are utilized.

The vertical take-off and the runway take-off consume a similar amount of energy in the initial phase. During vertical takeoff the HCAV must be accelerated in a vertical direction and during a runway takeoff the HCAV has to be accelerated in a horizontal direction up to the 1.3 times the stall velocity. In addition, in VTOL mode, upon reaching 20 m altitude, the HCAV has to be accelerated horizontally until it reaches 1.3 times the stall velocity. This phase is called transition. During the transition the tiltable DFs are rotated around their center axis (parallel to the Y axis). This is a critical phase, as explained above. The overall savings during short take off are up to 60%.

Reference is made now to FIG. 9, which is a graph depicting the altitude gained from takeoff versus distance when taking-off in VTOL (dashed line) mode and in STOL (full line) mode, according to embodiments of the invention. This graph clearly demonstrates the advantage of the short takeoff versus the vertical takeoff. The runway takeoff adds around 1000 meters or 14% range. This is due to the lifting capabilities of the HCAV design. Once, 1.3 times stall velocity is reached the propulsion system only has to provide enough thrust to maintain velocity. While it takes time to accelerate the vehicle after the transition during vertical take-off to produce lift, it is produced immediately after the vehicle starts during a short takeoff. In the STOL takeoff mode the wingtip DFs and the tail DF are tilted around the pitch-axis the Y-Axis) of the vehicle's coordinate system.

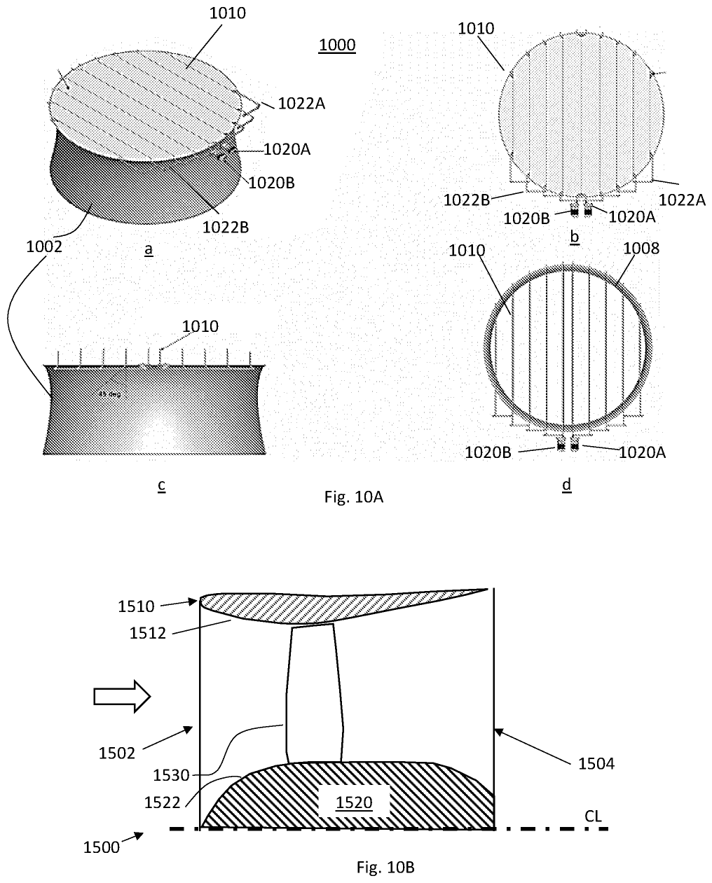

The fourth fan—the fuselage DF—is incorporated in the HCAV fuselage is a fixed DF with the direction of thrust pointing downwards along the yaw-axis (the Z-axis). It is intended for use during take-off and landing, with design parameter of at least four (4) minutes of hovering. During the level flight, the fuselage DF is covered by an openable cover system in order to keep the optimum aerodynamic surface. Reference is made now to FIG. 10A, which depicts cover system 1000 of a fuselage DF, in four views, according to embodiments of the invention. The cover system 1000 comprises a set of vanes 1010 operable by one or two servo motors 1020A, 1020B for changing the state of the vanes from open to close and vice versa. Servo motors 1020A, 1020B are connected, each, to a rotation transmission system 1022A, 1022B, respectively, adapted to transfer the rotational movement of the servo motors to the entire vanes. The inlet 1008 and outlet area (not shown) are covered by a set of ten (10) vanes each. View “a” demonstrates cover system 1000 in isometric view. View “b” depicts cover system 1000 in top view and vanes 1010 in “close” state. View “c” depicts cover system 1000 in side view and view “d” depicts cover system 1000 in top view and vanes 1010 in “open” state.

The set of vanes covering each of the opening is arranged in two halves—five vanes in each—and adapted to open by rotation in opposite directions. The left side opens clockwise and the right side opens counterclockwise. Each rotation is controlled by duplex servos to ensure redundancy. The vanes may be manufactured out of carbon fiber to reduce weight, but can also be manufactured of any light-weight material, e.g. aluminum, titanium etc. Those vanes have cut-outs at the end of the vane, closest to the duct, so they do not collide with the duct during the opening process. The design is chosen to minimize the uncovered area during flight, when the vanes are closed. To ensure a tight closed surface the vanes are tapered on both ends. One fillet is facing inside one is facing outside. This way the vanes can overlap and ensure a smooth surface. Therefore, the drag is minimized when closed. The vanes 1010 are pivotally connected to the duct via axes and bearings.

The covering can be, but is not limited to, controlled by a flight computer system. Using the coverable fuselage DF allows HCAV to provide enough thrust for vertical takeoff and to accelerate to and keep the necessary flight velocity to provide sufficient aerodynamic lift, and at the same time to keep the fuselage drag to a minimum during level flight. In an case of an emergency landing the fuselage DF can be utilized to lower or stop a vertical descent and is therefore part of the safety measures of the HCAV, according to embodiments of the invention. The advantages of the fuselage DF include the inlet and outlet of the DF. The inlet is designed to maximize the intake air and to accelerate the air around the unique design of the fuselage of the HCAV thereby to produce additional aerodynamic lift during takeoff and landing. The outlet is designed to maximize the efficiency during takeoff and landing, by utilizing an accelerating shroud design of the duct. An accelerating shroud design comprises an aerodynamic profile of the inner face of the duct that narrows from the inlet towards to plane where the fan rotates and widens thereafter toward the outlet of the duct. The accelerating shroud can take higher blade loads and is therefore more efficient. The downside is the higher noise generated by such a DF. The installation of the fuselage DF in the HCAV body provides also extended mechanical protection to the fans' blades and motor.

The following parameters are involved in the design of a fuselage DF: inlet cross section area, outlet cross section area, the profile of the inner face of the duct (leading and trailing edges), the pitch angle of the fan blades, fan blades profile and the power demand in operation. The requirements for level flight and VTOL are opposed—large inlet and outlet areas for vertical take-off and landing, while smaller, more straightened profiles are preferred for level flight. The fuselage DF is therefore optimized for vertical takeoff and landing. The effort of optimizing the fuselage DF is mostly concentrated on the inlet and outlet of the fan. Since an accelerating shroud increases the air velocity towards the blades and then lowers it after the propeller the blades take higher loads and therefore the efficiency increases. Therefore, the inlet area has a nozzle design, while the outlet area is designed as a diffuser, carefully designed to not cause the air flow detach from the nozzle surface. Another part of the optimization is to maximize the inlet velocity in order to utilize the above mentioned Coanda-effect. The optimization efforts are carried out in a parameter sweep study fashion.

Tiltable DFs design considerations: The tilt-able DFs are designed to provide enough thrust during takeoff/landing and level flight. It states a compromise between those two requirements. The blades are designed to minimize the blade tip loss and to optimize the thrust in regard to the duct design. As the pitch angle of the blade changes along the length of the blade as part of the blade design, in order to get the best overall power to thrust ratio in changing flight conditions. A specific design of duct assembly 1500 for DFs is depicted in FIG. 10B, to which reference is now made. Ducted fan assembly 1500 is shown in cross section view showing half of the cross section extending from the center line (CL) outwardly. Ducted fan assembly 1500 comprises shroud 1510 having an aerodynamically shaped internal face 1512, fan spinner 1520 having an internal face 1522 and fan 1530 adapted to rotate with the spinner 1520. The inlet to ducted fan assembly is denoted 1502 and the outlet is denoted 1504. Ducted fan assembly 1500 is circularly symmetric about its center line CL. As seen in FIG. 10B the cross section area for incoming air, extending between inner face 1512 of duct 1510 and inner face 1522 of spinner 1520 decreases as the air progresses from the inlet 1502 towards blades 1530, and increases thereafter as the air approaches outlet 1504. As a result the air flowing through ducted fan assembly 1500 accelerates (also) due to the specific design of ducted fan assembly 1500. Thus design is proved to have high efficiency when the ducted fan provides vertical thrust. This design was calculated using parameter sweep study technic.

Tiltable tail DF takes also part in the control and maintenance of the HCAV stability. Tail DF incorporates two flight control fins, a rudder and an elevator respectively, which are responsible for the pitch and yaw control of the aircraft, as explained also herein above. The control of the rudder and elevator fins is done by a control system incorporating a control computer. The control system tilts tail DF as well as establishes the necessary angle of the yaw and pitch fins by controlling the angles of the rudder and the elevator. In order to be able to maneuver in all flight modes both, the rudder and the elevator must be able to deflect independently. The rudder and elevator system includes the activation, wiring and mounting as well as the control system, which controls the movability of the rudder and the elevator during rotation of the tail DF. To ensure the independent movement of the rudder and the elevator, cut-outs have been established in both the rudder fin and the elevator fin, as seen for example in FIG. 4.

Stabilization considerations: In order to minimize the stabilization required effort, the HCAV according to embodiments of the invention is designed with a partly forward swept wing. The body design of the HCAV brings the Center of Gravity (CG) to the front, because of the space restrictions. This means that with the given space the systems and the payload/passengers are located at the front of the vehicle. To minimize the stability effort the Center of gravity is also pushed forward to shorten the moment lever and by that to reduce the stabilizing moments. This design enables utilizing the optimized fuselage shape. The positioning of the wing with respect to the fuselage is optimized also as to provide strong structure when in flight mode and to enable optimal folded shape when in drive mode.

Size and measurements considerations: The design of the HCAV that is discussed above operates with four (4) DFs, but same or very similar design considerations may be applied when a HCAV with another number of DFs is considered. The number of fans may vary between three (3) and up to sixteen (16) DFs as may be dictated by the absolute and final dimensions and weight of the required other HCAV. The current dimensions and number of fans are driven by the road regulations and the number of passengers. Nevertheless, the design discussed herein is scalable and therefore a version with up to 20 passengers or a payload of up to 1600 kg, as a sort of mass transportation system, is feasible. Since the fans are only scalable up to a certain diameter, more fans must be incorporated within and outside of the fuselage.

Since this HCAV is designed to transport people (as opposed to freight) the length of the HCAV fuselage is driven by the space for the passengers. At average one passenger seat in economy class ranges between 0.71 m and 0.79 m. Since the width of HCAV cannot exceed a given upper limit due to street regulations the only possible way to add more passengers is to lengthen the HCAV cabin to fit more passengers. For example to fit in 8 more people the passengers cabin would be 6.3 m longer. The overall aerodynamic as well as system design remains the same with the exception that the size and number of DFs should be sufficient for takeoff, travel and land with the extended number of passengers.

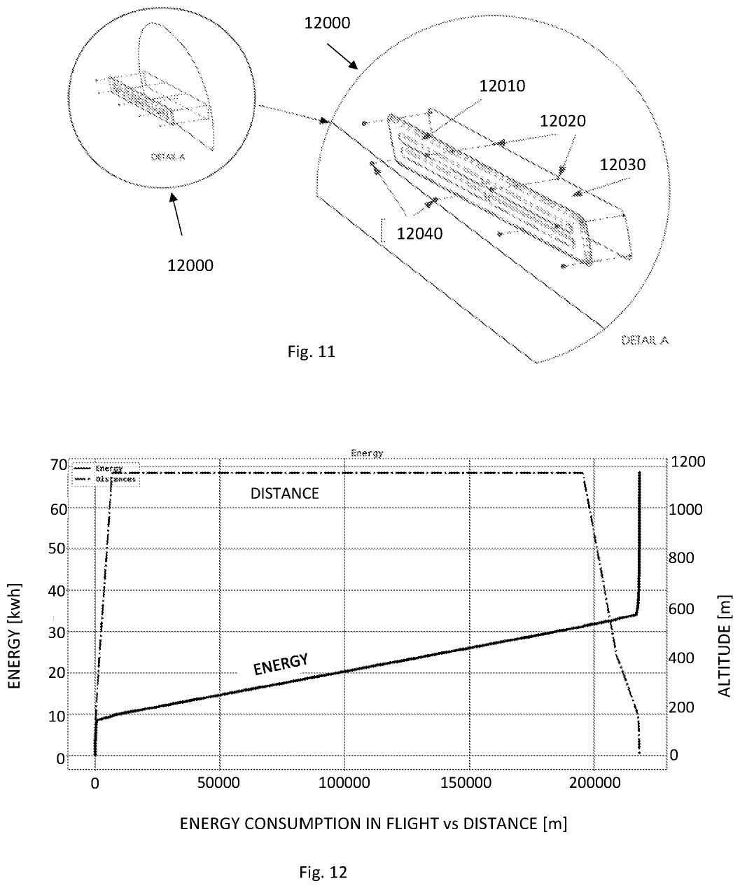

Side protectors/Shock Absorbers—Drive Mode: an HCAV according to embodiments of the invention is designed for a drive and fly mission. This means that in drive mode the road regulations are in place, while during its flight the flight regulations (e.g. FAA rules) will be applied. Since the air worthiness has to be given at all times, small accidents during the drive mode must be taken into account. It is almost inevitable that small bumps and scratches will occur during operation in drive mode, therefore, to ensure airworthiness after a limited road collision, the mechanical impact must be properly absorbed. In order to be able to fly after being involved in a limited road accident, the relevant areas of the vehicle, that are mostly expected to be involved in such accidents, may be protected by a shock absorbing system. Reference is made to FIG. 11, which is a schematic illustration of a replaceable shock absorbing system 12000, according to embodiments of the present invention. System 12000 comprises panels 12010 to be installed over non critical and may be made of absorbing material, e.g. a foam panel. Panels 12010 may be attached over pre-made cavities 12030 in the outer skin of HCAV fuselage and be screwed by screws 12040 to the cavity in the surrounding surface of that specific area, for example the doors. In order to protect more critical areas two escalation steps may be taken. The first step includes springs placed between the shock absorbing material and the cavity. This way the absorbing of the impact is improved in accordance to the spring stiffness. High risk areas, e.g. the ducted fan in the back, may be protected with small pneumatic or hydraulic shock absorbing cylinders. Those cylinders may be placed instead of the screw attachment. The stiffness and the movement range can be adjusted by the fluid installed in the cylinders.

Propulsion options: Ann HCAV according to embodiments of the invention is primarily designed to fly and drive with electrical power. All fans, systems and wheels are operable by electrical power only. In light of the progress and availability of modern batteries, several propulsion options are taken into account. The source of the electrical power is interchangeable and can be provided by different systems. According to one approach the battery version relied upon is an available battery designs, which are readily achievable in the market. In order to provide the necessary range and/or flight time, calculations were done with prospective battery designs. The necessary specifications are provided by manufacturers working on those batteries. In some embodiments a battery having capacity of 790 kw manufactured by Kokam Ultra High Power Ltd. may be used. When more powerful batteries will be available, such as a 1166 kw battery (by Licerion High Power) they may replace current batteries. This design provides a range up to 200 km (124 mi) with a payload of 320 kg (705 lb) (corresponds to four passengers). The overall range and flight time is depending on the vehicle size, environmental conditions and payload (including passengers). Details of the batteries available today and future expected batteries are given below:

Battery Configuration for the 2020 Kokam Ultra high Power:

| | | |
|---|---|---|
| Battery | # of Packs | 2 |
| Configuration | Total Power (kW) | 790 |
| | Total Energy (kWh) | 40 |
| | Total weight (kg) | 361 |
| | Elec. System Inefficiency | 0.8 |
| Battery | # of Packs | 2 |
| Sub- | Pack config (S) | 178 |
| configuration | Pack config (P) | 1 |
| #1 | Cell capacity (Ah) | 30 |
| | Cell Nominal (V) | 3.7 |
| | Cell cont. Discharge (A) | 600 |
| | Discharge Rate (C) | 20 |
| | Cell weight (kg) | 0.78 |
| | Pack weight addition (%) | 0.3 |
| | Pack nominal (V) | 658.6 |
| | Power per pack (kW) | 395.2 |
| | Energy per pack (kWh) | 19.8 |
| | Weight per pack (kg) | 180.5 |
| | Total Power (kW) | 790 |
| | Total Energy (kWh) | 40 |
| | Total weight (kg) | 361 |
| | Elec. System Inefficiency | 0.8 |

Expected performance and associated calculations when using future batteries from Licerion High Power is given below:

| | | |
|---|---|---|
| Battery | # of Packs | 6 |
| Configuration | Total Power (kW) | 1166 |
| | Total Energy (kWh) | 117 |
| | Total weight (kg) | 378 |
| | Elec. System Inefficiency | 0.8 |
| Battery | # of Packs | 6 |
| Sub- | Pack config (S) | 202 |
| configuration | Pack config (P) | 1 |
| #1 | Cell capacity (Ah) | 26 |
| | Cell Nominal (V) | 3.7 |
| | Cell cont. Discharge (A) | 260 |
| | Discharge Rate (C) | 10 |
| | Cell weight (kg) | 0.24 |
| | Pack weight addition (%) | 0.3 |
| | Pack nominal (V) | 747.4 |
| | Power per pack (kW) | 194.3 |
| | Energy per pack (kWh) | 19.4 |
| | Weight per pack (kg) | 63.0 |
| | Total Power (kW) | 1166 |
| | Total Energy (kWh) | 117 |
| | Total weight (kg) | 378 |
| | Elec. System Inefficiency | 0.8 |

The calculation of the range is driven by the energy demand of each flight phase. In order to get the overall range, the inevitable flight phases are calculated first.

Means, vertical take-off, transition to climb, transition to land and vertical landing are calculated and the energy needed is subtracted from the overall energy of the propulsion system. Then, the climb phase and descent phase is calculated and last but not least the remaining energy is used to make distance. The energy demand for each flight phase is depicted in FIG. 12. It shows the range over height (dash-dotted line, right axis) and the energy demand over range (solid line, left axis).

In another design approach the HCAV comprises a hybrid propulsion system which relies on one or more engines, one or more batteries, an electrical generator and a power distribution system. The engines may comprise one or more from a list including power shafts, aviation and/or conventional gasoline/diesel engines and/or hydrogen fuel cells. The power of the engine is transformed into electrical energy by the electrical generator, which may be provided by an external supplier. The electrical generator is designed to provide high power during take-off and long lasting power during level flight. It is combined with a state-of-the-art-battery to optimize the efficiency of the HCAV. A power distribution system is designed to distribute the power to the flight systems, drive systems, ducted fans, flight control surfaces, lights and any other electrical source. The distribution system includes the capabilities to prioritize and redistribute the power of the battery as well as the engine. It is designed to foremost secure safe flight for the passengers and/or payload. The system may also provide double redundancy by design. In the very unlikely case of a power loss of both propulsion systems the HCAV is still able to glide to the next landing opportunity (radius of up to 12 km) and perform a safe landing. The hybrid version of the propulsion system is capable of flying a range up to 500 km (310 mi), depending on the incorporated engine with a payload of 320 kg. A more detailed description of the calculations is associated with a hybrid propulsion system is given below:

| Engines | Fuel | Energy [kWh] | Fuel-Capacity |
|---|---|---|---|
| UL520 iS | Gasoline | 257 [KWh] | 80 [kg] |
| by: ULPower Aero Engines | | | |
| TDA CR2.0 16 V | Diesel | 154 [KWh] | 40 [kg] |
| by: Dieseljet | | | |

According to some embodiments of the invention a turboshaft engine may be used instead of gasoline/diesel internal combustion engine for recharging batteries.

Power Regain: According to embodiments of the invention an HCAV is able to harvest power back during flight by utilizing the wingtip DFs. The wingtip DFs may be used as a wind turbine, when not in use for forward thrust, e.g. during the descent phase. During the descent phase of a flight the glide ratio of the HCAV produces enough lift to descent safely to the altitude of the transition. During that phase the wing tip DFs are not used to generate thrust. In that timeframe the air flow velocity is spinning the fan freely. To harvest power from the fan, the power flow to the DFs motors is reversed. The harvested energy is calculated with commonly known wind turbine formula:

Power=k*Cp*0.5* [symbol] *ν³*A

The power is driven by the flow velocity v going through the disk area A. The Cp value is the power coefficient of the ducted fan. With the air density [symbol] and the yield power constant, the theoretical power can be calculated in kW. In common a wind turbine the slow turning power shaft connected to the fan is geared up by a factor of 100 to generate energy. Since at the HCAV the fan turns very fast, no transmission is needed. Therefore, the energy equation must be divided by a factor. Furthermore. the efficiency of the motor must be taken into account. The motors considered to power the DFs in the HCAV have substantially same efficiency coefficient when working as a motor or as an alternator.

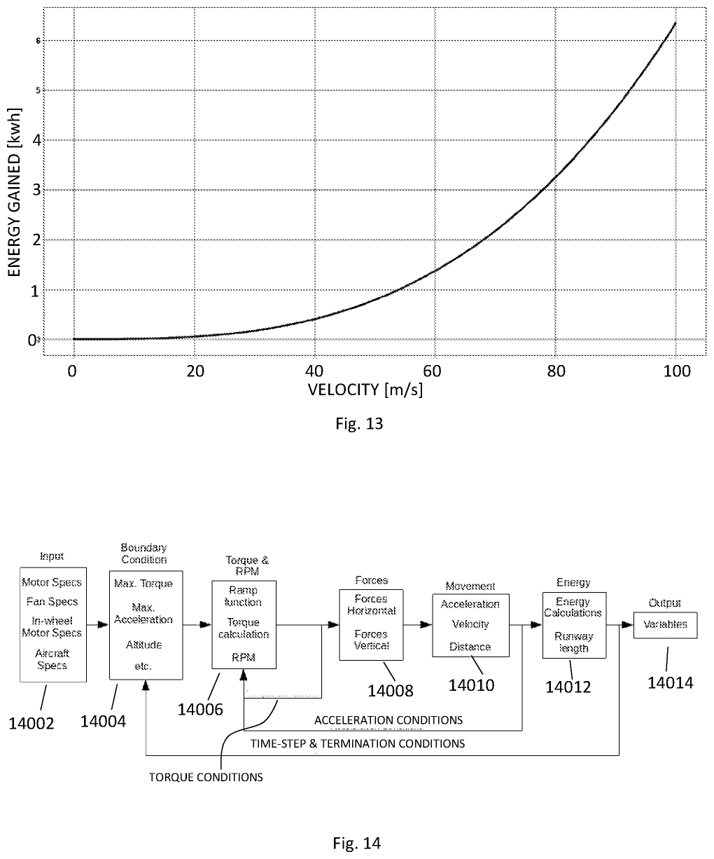

Reference is made to FIG. 13, which is a graph showing the amount of gained energy during 5 minutes as a function of the air flow velocity through the DFs, according to embodiments of the invention. For example during a normal descent phase of the flight the DF may experience a flow velocity of around 60 m/s. This leads to a power gain of 18 kW per fan and thereby produces around 1.4 kWh energy. Utilizing both DFs the energy gain doubles. This means, up to 7% of the battery capacity can be harvested during the flight mission profile. Nevertheless, the additional drag introduced by these measures will increase the sink rate during descent. In order to reduce the noise in crowded areas the HCAV can takeoff powered by batteries only, which is expected to lower the noise significantly.

Vehicle dimensions: The smallest HCAV design may fit at least a passenger with personal items, flight and drive systems and the ducted fans. The design that is discussed in details herein is capable of accommodating four (4) adult persons during driving and flying. The dimensions of the vehicle are driven by the payload and systems necessary to comfortably and safely transport its payload. The overall dimension varies between phases of a typical mission. In order to utilize the aerodynamic effects of a fixed wing aircraft and comply with road regulations, the HCAV comprises fold-able wings. This means that in drive mode the wings are securely stowed above the fuselage and are able to unfold before takeoff. The folding mechanism that was described above is adapted to automatically fold and unfold the wings as part of the transition between the modes of operation. The size of the wing is driven by the weight and dimensions of the vehicle. In order to comply with the design requirements, the wing must be folded in at least two (2) places. In the design described herein the half span wing is folded at the midsection of the wing and at the wing's root. The midsection folding mechanism is intended to fold the outboard section of the wing 180 degrees in upward directions (around the roll axis) and lay on top of the inboard section. The mechanism itself includes the turning hinge, the actuators systems, the locking mechanism for drive mode as well as flight mode and active communication systems of the wing with the HCAV power source(s) and the control system. The wing's root mechanism is designed to fold 90 degrees around the yaw axis. It includes the mechanism itself, the electrical actuator, the locking mechanism and active communication systems of the wing with the HCAV power source(s) and the control system, adapted also to secure electrical power to the systems in the wing, e.g. the ducted fan and the control surfaces. In order to fully turn and stow the wings above the fuselage, the midsection of the HCAV includes a fairing aerodynamic surface, such as fairing surface 6050 of FIGS. 6A-6F. This mechanism operates the midsection of the fuselage. It is intended to automatically pivotally open a part of the fuselage roof to make room for the folding wings. It also includes a latch to securely close the fuselage during flight.

The HCAV's dimensions must comply with road vehicle regulations, which limit its dimension in drive mode to be in accordance with the regulations. Within those regulations the dimensions may vary. See table 2 below, depicting overall dimensions in drive mode:

TABLE 2

| | Length [m] | Width [m] | Height [m] |
|---|---|---|---|
| Minimum | 4 | 1.5 | 2 |
| Maximum | 12 | 3 | 4 |

Due to the fixed wing design, the dimensions vary during takeoff, flight and landing. In that case the overall size is driven by the wingspan, which is related to the overall size of the vehicle, as depicted in table 3 below:

TABLE 3

| | Length [m] | Width [m] | Height [m] |
|---|---|---|---|
| Minimum | 4 | 10 | 2 |
| Maximum | 12 | 40 | 4 |

System avionics architecture: The purpose of the avionics of the HCAV is to allow fully automated and autonomous capability for the vehicle in its flight mode of operation. Beyond the autonomous functionality, there is an interface to the external environment. This relates mainly to the passenger in the HCAV in drive mode of operation, who can interact with the vehicle, command destinations, routes etc. and to the virtual air traffic control that allows the vehicle to enter the “sky roads” safely and use it efficiently with specific allocation. The central computer receives input from various sensors and generates commands to the control means (propeller motors, aerodynamic surfaces, drive motor, steering wheel and brakes).

Reference is made now to FIG. 14, which is a schematic flow diagram 14000 depicting a process for calculating and controlling the physical flight operators (thrust magnitude and direction, rudder and elevator angles, motor power to the wheels) associated with the autonomous or manual control of the HCAV, according to embodiments of the invention. In block 14002 the calculations begin with the receiving of input data. The input information may comprise the overall propulsion system specifications, e.g. the energy of the battery, the maximum torque it can handle etc. The DFs specifications are given by the inertia of the fan, the maximum RPM, the thrust etc. Same for the in-wheel motor. Those parameters are given by the manufactures of those parts. The HCAV specifications were described above for the design depicted and described in the current specification. It includes the design parameters (MToM, dimensions, etc.) and the aerodynamic parameters (lift coefficients, drag coefficients, etc.). In addition to that the boundary condition must be set (block 14004). This is partly done by the specification given before, for example the maximum torque the engine can provide. Other boundary conditions may be set by the user, for example the maximum acceleration and the altitude. In this case the altitude ranges from 0-20 meters and is set as a termination condition. Since the solving process of the equations is done for every single time step, an appropriate time frame must also be chosen. After that, the program starts to analyze the torque during the warm up of the engine, which means that the fans and the in-wheel motors have to ramp up/down to a certain RPM (block 14006). During that time the torque is calculated and if necessary the time constant (parameter of the propulsion system—not the time step of the program) is adjusted to not exceed the maximum torque of the propulsion system. This has to be done every time the RPM is changing. If all the parameters are in the respective limitations, the RPM at that specific time frame is used to calculate the thrust (block 14006). The thrust, the aerodynamic forces and the friction between the wheels and the ground are taken to calculate the required force vector (block 14008). At this stage the mass is constant and set to the maximum take-off mass (MToM). With this information the acceleration vector can be calculated, as well as the velocity vector and the distance traveled horizontally and vertically (block 14010). If the acceleration is higher than the maximum allowed, the RPM is adjusted until this criteria is satisfied (block 14010). After that the energy demand is calculated and the distance of this time frame is added to the runway length and the next time step is calculated (block 14012). After an altitude of 20 meters is reached the program terminates and provides certain variables useful for further analysis (block 14014). The process described above utilizes three (3) feedback loops. First feedback loop returns torque conditions results of block 14006 back to that block in order to provide fail-safe conditions. For example, if the produced torque is too high the ramp-up speed will be lowered. One purpose is to set the power control time constant to minimum possible thereby to minimize energy losses occurring due to rapid and strong changes incurred by the control loop. The second feedback loop returns the output acceleration conditions from block 14010 back to block 14006, in order to control the HCAV maximal acceleration below a predefined threshold. For example. An acceleration threshold for a

HCAV carrying passengers may be set to 3 m/s², which is considered acceptable to a passenger. The third feedback loop returns the output results of time-step and termination conditions from block 14012 to block 14004, in order to enable mission-specific parameters to provide mission envelope for the control system, and to enter into effect end-of-mission terms and parameters.

Situation awareness and Collision Avoidance System: Safety is the most important key element of the vehicle. As part of the safety management, the vehicle is integrated with a safeguard that is responsible to detect potential collision risks and eliminate them by active avoidance maneuver. It includes both on board sensors and communication with other sky users and air traffic control.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1-16. (canceled)

17. A vehicle configured for travelling on a road and for flying in the air, the vehicle comprising:
a fuselage extending along a horizontal longitudinal roll axis of the vehicle;
a pair of wings, each extending, in a deployed position, from the fuselage along a horizontal lateral pitch axis thereof, each wing comprising a root folding mechanism configured to pivot its respective wing about a vertical yaw axis into a stowed position in which it overlies the fuselage; and
at least three wheels configured to facilitate travelling on the road; and
at least two fans configured to provide thrust for flying the vehicle, wherein each of said wings carries at least one of said fans.

18. The vehicle according o claim 17, wherein each of said wings further comprises:
an inboard wing pivotally articulated to the fuselage, and an outboard wing pivotally articulated to the inboard wing; and
a mid-wing folding mechanism configured to pivot the outboard wing to overlie the inboard wing, wherein in the stowed position the outboard wing overlies the inboard wing.

19. The vehicle according to claim 18, wherein each of the mid-wing folding mechanisms comprises an actuator configured to facilitate the pivoting of the outboard wing over the inboard wing, and locking means configured to securely lock the respective outer main part of the wing in the stowed position and the deployed position.

20. The vehicle according to claim 18, wherein each of the mid-wing folding mechanism is configured to pivot its respective outboard wing about the roll axis when the wing is in its deployed position.

21. The vehicle according to claim 17, wherein said fans are configured to be selectively tilted about the pitch axis when the wings are in their deployed position.

22. The vehicle according to claim 21, wherein said fans are configured to be tilted independently of said wings.

23. The vehicle according to claim 17, wherein each of the root folding mechanisms comprises an actuator configured to facilitate the pivoting, and locking means configured to securely lock the respective wing in the stowed position and the deployed position.

24. The vehicle according to claim 17, wherein the overall width of the vehicle, when the wings are in their stowed positions, does not exceed 3 m.

25. The vehicle according to claim 17, wherein the overall height of the vehicle, when the wings are in their stowed position, does not exceed 4 m.

26. The vehicle according to claim 17, wherein the dimensions thereof when the wings are in their stowed positions conform to size regulations for road vehicles.

27. The vehicle according to claim 17, wherein at least one of said wheels is motorized.

28. A vehicle according to claim 17, wherein each of said fans is each configured to rotate about a respective rotation axis and to deliver thrust in a direction along said rotation axis, each of the fans being further configured to be selectively tilted about the pitch axis, when the wings are in their deployed position, to position its rotation axis along one of a vertical direction, a horizontal direction along the roll axis, and at least one tilted direction at a tilt angle between said vertical and horizontal directions, the vehicle being configured to tilt said fans so as to position said rotation axis along said tilted direction during takeoff, thereby performing a short runway takeoff.

29. The vehicle according claim 28, said vehicle being configured to drive at least one of said wheels during the short runway takeoff.

30. The vehicle according o claim 29, wherein the vehicle is configured to selectively allow free spinning of said wheels during the short runway takeoff.

31. The vehicle according to claim 28, wherein each of the fans is configured to be tilted about the pitch axis to position its rotation axis along one of a plurality of tilt angles.

32. The vehicle according to claim 31, wherein said plurality of tilt angles comprises a continuous range between said vertical and horizontal directions.

33. The vehicle according to claim 17, being configured to perform a vertical takeoff.

34. The vehicle according to claim 17, wherein at least one of said fans is disposed in a tail portion of the fuselage.

35. A vehicle configured for travelling on a road and for flying in the air, the vehicle comprising:
a fuselage extending along a horizontal longitudinal roll axis of the vehicle;
a pair of wings, each extending from the fuselage along a horizontal lateral pitch axis thereof;
at least three heels configured to facilitate travelling on the road; and
a plurality of fans each configured to rotate about a respective rotation axis and to deliver thrust in a direction along said rotation axis, each of the fans being further configured to be selectively tilted about the pitch axis to position its rotation axis along one of a vertical direction, a horizontal direction along the roll axis, and at least one tilted direction at a tilt angle between said vertical and horizontal directions;
wherein the vehicle is configured to tilt said fans so as to position said rotation axis along said tilted direction during takeoff, thereby performing a short runway takeoff.

36. The vehicle according to claim 35, wherein each of the fans is configured to be tilted about the pitch axis to position its rotation axis along one of a plurality of tilt angles.
